(19) United States
(12) Patent Application Publication
(10) Pub. No.: US 2009/0181612 A1
(43) Pub. Date: Jul. 16, 2009

(54) METHOD FOR BROADCAST RADIO TRANSMISSION OF A MULTIPLICITY OF DIFFERENT INFORMATION PRESENTATIONS, AND TRANSMISSION AND RECEPTION DEVICE FOR THIS PURPOSE

(76) Inventor: Gunther May, Braunschweig (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/091,984

(22) PCT Filed: Nov. 1, 2005
(86) PCT No.: PCT/EP05/11670

§ 371 Date: Sep. 3, 2008

(51) Int. Cl. H04H 20/71; H04J 3/00

(52) U.S. Cl. 455/3.01; 370/345

(57) ABSTRACT

Disclosed is a method for radio broadcasting a plurality of different information offers in a terrestrial mutual broadcasting system (1) on a common channel with radio broadcast signals in a time slot process. According to said method, at least one transmission time slot is allocated to each information offer in order to radio broadcast the information offer, a radio broadcast signal is provided with a plurality of global time windows with at least one respective transmission time slot over time, and the radio broadcast signal is transmitted by a plurality of spaced-apart transmission devices (3) in such a way that the global time windows of the radio broadcast signals transmitted by the transmission devices (3) contain the same information offers while the allocation of the transmission time slots of the global time windows is identical with the information offers. According to the invention, the ratio broadcast signals are also provided with local time windows with transmission time slots which are allocated to local information offers, radio broadcast signals transmitted with identical information offers in the global time windows by at least two spaced-apart transmission devices (3) on the same channel being provided with different information offers in local time windows.

Method for broadcast radio transmission of a multiplicity of different information presentations, and transmission and reception device for this purpose

The invention relates to a method for broadcast radio transmission of a multiplicity of different information presentations in a terrestrial common-frequency broadcasting network on a shared channel with broadcast radio transmission signals using the time slot method, in which every information presentation has at least one associated transmission time slot for broadcast radio transmission of the information presentation, and a broadcast radio transmission signal has a multiplicity of global time windows over time with at least one respective transmission time slot, and the broadcast radio transmission signal is broadcast by a plurality of transmission devices, which are arranged at a physical distance apart, such that the global time windows of the broadcast radio transmission signals which are broadcast by the transmission devices contain the same information presentations, and the association between the transmission time slots in the global time windows and the information presentations are identical.

The invention also relates to a transmission device for broadcast radio transmission of a multiplicity of different information presentations in a terrestrial common-frequency network on a shared channel with transmission signals using the time slot method with such a broadcast radio transmission method, having a radio transmission unit and a mixing unit for mixing information from different information presentations into the broadcast radio transmission signal.

The invention also relates to a reception device for receiving broadcast radio transmission signals transmitted using the broadcast radio transmission method, where the broadcast radio transmission signals respectively have a multiplicity of different information presentations, and every information presentation has at least one associated transmission time slot for broadcast radio transmission of the information presentation, and a broadcast radio transmission signal has a multiplicity of global time windows over time with at least one transmission time slot, and the global time windows broadcast radio transmission signals which are broadcast simultaneously by a plurality of transmission devices arranged at a physical distance from one another contain the same information presentations, and the association between the transmission time slots in the global time windows and the information presentations is identical, having a radio reception unit and a decoding unit for decoding the received digital broadcast radio signals.

Two different types of digital terrestrial broadcast radio networks are known, namely multifrequency networks and common-frequency networks. In multifrequency networks, the presented services (information presentations) are broadcast on different carrier frequencies or channels. This allows the broadcast services to be designed differently from one another between the various transmitters. Such services or information presentations may be television or radio programs, for example. Similarly, information presentations may also be traffic messages, weather information or other special information.

By contrast, all the transmitters within a region in a common-frequency network transmit totally identical services on one and the same carrier frequency and one and the same channel. That is to say that the broadcast radio transmission signals which are broadcast by a multiplicity of physically spaced transmitters in a region have the same content and the transmitters are coupled so as to be locked in frequency and phase.

So that a plurality of services can be presented on one and the same frequency, the individual services can be broadcast in transmission time slots. When transmitting using the time slot method, time intervals are provided in which respectively determined data packets are transmitted for a specific service. When a time which follows a transmission time slot and which is used to transmit information from other services has elapsed, the relevant service is assigned a new transmission time slot again. This method is known from European Standard ETSI EN 302 304 “Digital Video Broadcasting (DVB)—Transmission System for Handheld Terminal (DVB-H)”. In this context, the broadcast radio transmission signals are transmitted in transport data stream packets encoded on the basis of the MPEG standard. Data from an information presentation are received intermittently in this case, which means that reproducing an information presentation in the receiver requires the presence of a buffer for the received data from an information presentation in order to allow continuous reproduction.

The advantage of transmitting data from an information presentation in transmission time slots is that the power consumption can be reduced, particularly in the case of portable receivers, by switching off the reception unit in the interim period between two successive transmission time slots for an information presentation provided for reception.

In the case of broadcast radio transmission in digital terrestrial common-frequency networks, there is a problem in that the plurality of transmitters in a region can broadcast only totally identical services, and differing local services can be broadcast by individual transmitters only to a restricted degree.

DE 101 39 069 A1 describes a method in which regionally determined local programs can be inserted into a broadcast radio transmission signal which is broadcast using a DVB common-frequency network. In this case, a program which is broadcast throughout a state using a DVB common-frequency network is replaced by at least one regional program. The nationwide global services or programs are replaced merely by regional services or programs. Within the regional common-frequency network, simultaneous broadcasting of global services and local services is not possible, since the individual transmitters within the regional common-frequency network must continue to broadcast exactly the same broadcast radio transmission signal.

In addition, DE 44 24 778 C1 discloses a method in which a stereo transmission channel for broadcast radio transmission is split into two monotransmission channels. The monotransmission channels are engaged with a program only by certain transmitters. It is therefore possible to transmit two local broadcast radio programs in a single transmission channel. It is not possible to broadcast more than two services per channel, however.

DE 41 02 408 A1 describes a method for transmitter or regional identification in common-frequency networks, in which, in addition to a service which is broadcast in a common-frequency network, a regionally differing supplementary carrier frequency is broadcast which can be used to present local services. A disadvantage is that additional carrier frequencies are required in order to broadcast the local service.

DE 42 22 877 A1 describes a method for transmitting regionally different information in common-frequency networks, in which data are transmitted in time slots which are not used by a common-frequency signal. Unlike in common-frequency mode, however, these data are broadcast on different carrier frequencies for every transmitter using time-division multiplexing. Again, a drawback is that a plurality of carrier frequencies is required and a receiver needs to switch from one carrier frequency to the other carrier frequency. To transmit local information presentations, it is therefore not possible to use the advantage of a common-frequency network.

One problem of broadcasting local information presentations in a terrestrial common-frequency network which result in different broadcast radio transmission signals from physically spaced transmitters is therefore firstly that absolutely identical broadcast radio transmission signals are required in the common-frequency network which are broadcast simultaneously in a region on a single carrier frequency by transmitters which are coupled so as to be locked in frequency and phase. Secondly, it is a problem that the transport data streams are usually transmitted using an interleaving method in order to protect the data transmission from what are known as burst errors. This involves utilizing the characteristics of the burst errors that, when they occur, they destroy a relatively large number of cohesive bits but are actually relatively rare. Re-sorting the data causes the burst errors to act as single errors at individual points in the original data stream and to lose their cohesiveness. In connection with additionally transmitted error correction information, it is then possible to correct the single bit errors if the data to be transmitted are scrambled in chronological order. Error control methods (e.g. checksum methods, convolution methods) also disperse the data streams over time.

When broadcast radio transmission signals having partially different contents are transmitted by a plurality of physically spaced transmitters for the areas in which the broadcast radio transmission signals overlap, this results in absolutely unusable signals which can no longer be decoded.

It is therefore an object of the present invention to provide an improved method for broadcast radio transmission of a multiplicity of different information presentations in a terrestrial common-frequency broadcast radio network on a shared channel which can also be used by single transmitters to broadcast different regionally limited local information presentations simultaneously with global services.

The object is achieved by means of the invention using the method of the generic kind in which the broadcast radio transmission signals continue to have local time windows with transmission time slots which are associated with the local information presentations, with broadcast radio transmission signals which are broadcast by at least two physically spaced transmission devices on the same channel and have identical information presentations in the global time windows having differing information presentations in local time windows.

It is therefore proposed to provide not only the global time windows but also local time windows in the broadcast radio transmission signal which are reserved for the local services or information presentations. Within the local time windows, single transmitters can transmit different contents, so that the broadcast radio transmission signal from transmission devices which are arranged at a physical distance from one another, possibly next to one another, is able to be distinguished in the local time windows.

When defining global and local time windows, the global information presentations can be received at unchanged long range in a region, while the local information presentations can be received in physically restricted transmission regions for the individual transmitters. Although the actual reception range for the individual transmission devices is reduced for reception of the local information presentations, since the regions of overlap between broadcast radio transmission signals which are broadcast by the transmission devices cannot be used, the subregions of the transmission devices which are able to receive the local information presentations continue to be large enough in order to allow the method to be used in practice.

It is particularly advantageous if the broadcast radio signals have at least one transition time interval in the transition between a global time window and a local time window and/or in the transition between a local time window and a global time window.

This transition time interval can be used to allow proper decoding of the broadcast radio transmission signal even with encoded transmission with transport data streams possibly in connection with error correction and interleaving methods. This is because the transmission time intervals ensure a defined transition between the global and local time windows.

It is particularly advantageous in this context if the transition interval is at least as long as the length of the time interval affected by the broadcast radio transmission signal prior to the transition interval by interleaving and/or error control methods, which means that the broadcast radio transmission signal is no longer affected thereby after the transition interval. That is to say that re-sorting and scrambling take place only within the global time windows and transition intervals or transition intervals and local time windows and hence it continues to be possible to decode the broadcast radio transmission signal even when broadcast radio transmission signals are broadcast by neighboring transmitters with different contents in the local time windows.

The transition time interval is preferably used to transmit empty packets of defined content which are not relevant to the transmitted information presentations. Such empty packets are defined in the MPEG standard, for example. When broadcast radio transmission signals are subject to interference, the loss of such data does not affect the reception of the global information presentations.

The method may involve variable association of the length of the time slots in global and/or local time windows and/or the length of the global and/or local time windows in a manner which is known per se. That is to say that the transmission capacity can be matched to the need of the individual information providers, and also an optimum capacity split between global and local information presentations is possible.

It is also an object of the invention to provide an improved transmission and reception device which can be used to broadcast and receive local information presentations in the common-frequency network on a shared carrier frequency.

The object is achieved by means of the invention with the transmission device of the type cited at the outset by virtue of the mixing unit being set up to mix local information presentations into transmission time slots in local time windows for the broadcast radio transmission signal, with broadcast radio transmission signals which are broadcast by at least two physically spaced transmission devices having differing information presentations in local time windows.

The object is also achieved by means of the invention with the reception device of the type cited at the outset by virtue of the decoding unit being set up such that local information presentations in the broadcast radio transmission signal are extracted from transmission time slots in local time windows for the received broadcast radio transmission signal which are respectively associated with the local information presentations, with broadcast radio transmission signals which are broadcast by at least two physically spaced transmission devices on the same channel having differing information presentations in local time slot groups.

This means that again the newly introduced local time windows are used for transmitting local information presentations in the common-frequency network on one and the same carrier frequency.

The invention is explained in more detail below using an exemplary embodiment with reference to the appended drawings, in which:

FIG. 1 shows an outline of a common-frequency network in a reception region with a plurality of transmission devices;

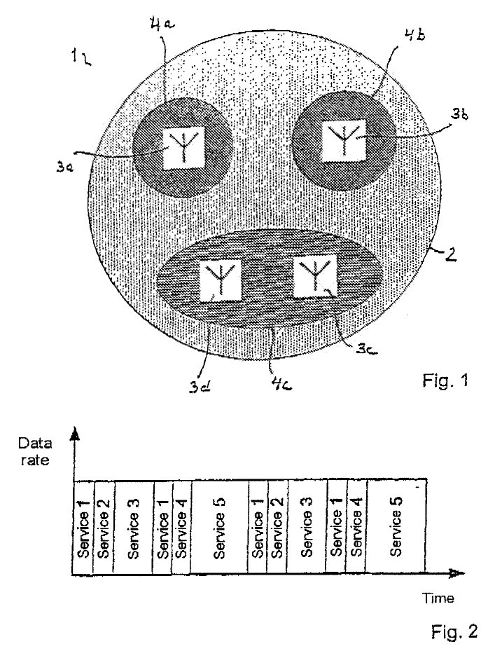

FIG. 2 shows a graph of the data rate of a broadcast radio transmission signal in the time slot method over time with a multiplicity of time slots for different information presentations;

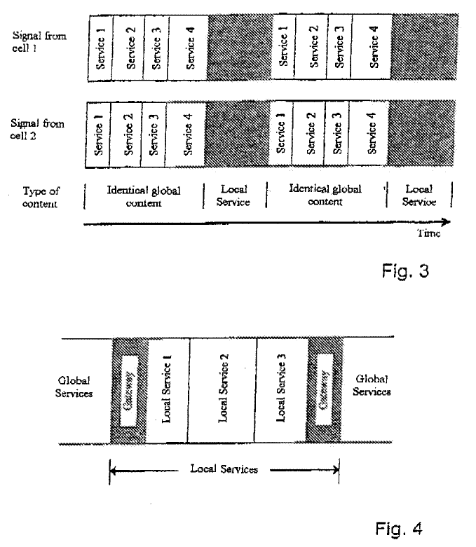

FIG. 3 shows a graph of the chronological split of broadcast radio transmission signals which are broadcast by the neighboring transmission devices into global and local time windows;

FIG. 4 shows a detail from the chronological split of a broadcast radio transmission signal from FIG. 3 with transition intervals before and after the local time windows.

FIG. 1 shows an outline of a common-frequency broadcast radio network 1 which has a plurality of transmission devices 3a, 3b, 3c, 3d in a distributed arrangement over a reception region 2. The transmission devices 3 are coupled to one another such that they are locked in frequency and phase and such that a broadcast radio transmission signal which is identical in global time windows is broadcast so as to be locked in frequency and phase in the entire reception region 2, i.e. that the broadcast radio transmission signal is broadcast on one and the same carrier frequency simultaneously by all the transmitter devices 3 in the reception region 2. When crossing the reception region 2, it is therefore possible to receive the same broadcast radio signal without changing the carrier frequency, without said broadcast radio signal being disturbed by interference in regions of overlap in the transmission ranges of neighboring transmission devices 3. In the case of digital broadcast radio transmission signals, such as are used in the DVB-H multiplex transmission method, in particular, an overlap in different broadcast radio transmission signals on the same carrier frequency result in an overlapped broadcast radio transmission signal which would be totally unusable.

Global and local time windows are therefore defined, with the transmission device 3 in a reception region 2 transmitting one and the same information within the global time windows. The broadcast radio transmission signals which are broadcast by the individual transmission devices 3 are therefore absolutely identical at least within the global time windows. The global information presentations which are broadcast within the global time windows can therefore be received within the whole reception region.

In addition, local time windows are defined in the broadcast radio signals, within which the individual transmission devices 3a, 3b, 3c, 3d can broadcast differing or the same information presentations according to requirements. The broadcast radio transmission signals can therefore differ from one another within the local time windows. This results in the broadcast radio transmission signal becoming unusable in regions of overlap between the transmission ranges of neighboring transmission devices 3a, 3b, 3c, 3d, and the local services not being able to be received there. If two neighboring transmission devices 3c, 3d broadcast identical local information presentations within the local time windows, the local service, i.e. the local information presentation, can also be received in the region of overlap for this transmission device 3c, 3d.

The reception subregions 4a, 4b, 4c for the local services are outlined by the different shadings in line with the different local services.

It becomes clear that both global and local information presentations can be received in the reception regions 4. In the other reception regions, on the other hand, only the global services can be received. Outside of the reception region 2, it is no longer possible to receive any service broadcast by the transmission devices 3 in the reception region 2.

In the case of the present method, the reception subregions 4 for the local services are generally smaller than if said local services were to be broadcast by a single transmission device 3 on a carrier frequency assigned exclusively to this transmission device 3, as will be the case in a multifrequency network. The reason for this is the interference with the broadcast radio transmission signals from other transmission devices 3 which are broadcasting different contents at the same time on the same carrier frequency, separated only by the physical distance. It has been shown through simulation that the reception subregions 4 within which local services can be received continue to be large enough to allow use of the method in practice.

FIG. 2 shows a graph of a data rate of a broadcast radio transmission signal over time, the broadcast radio transmission signal being split into time slots. A time slot is the periodic allocation of use for a firmly or variably prescribed time period.

Different information presentations, such as services 1 to 5, are allocated to different time slots. When the broadcast radio transmission signal is transmitted in time slots, time intervals are therefore provided which are respectively allocated to data packets for a service and in which no other different services are respectively broadcast. When a time which follows a time slot and in which other services (information presentations) are transmitted has elapsed, a corresponding service is again assigned a new time slot. The intervals between the time slots and the duration of the time slots can vary and do not need to be constant in terms of time. Accordingly, it is even possible in some cases for some services to be allocated more time slots than others, as outlined in FIG. 2. Service 1 thus has twice as many time slots as the other services 2 to 5, and the order of information presentations is as follows:
service 1-service 2-service 3-service 1-
service 4-service 5-service 1-service 2-
service 3-service 1-service 4-service 5- . . . .

FIG. 3 shows the split of a broadcast radio transmission signal based on the invention over time. It becomes clear that global time windows are provided for global information presentations, within which the split of the time slots over the information presentations, the intervals between the time slots and the length of the time slots for the broadcast radio transmission signals a and b which are broadcast by different transmission devices 3 are absolutely identical. In addition, local time windows are provided in which the broadcast radio transmission signals a and b from different transmission devices which are broadcast on one and the same carrier frequency may differ from one another.

Some of the total data rates of the broadcast radio transmission signal is therefore reserved for local services, which may have differing information presentations for different transmission devices. The local services may therefore differ from one another in different subregions of the terrestrial common-frequency network.

The local time windows are likewise divided into time slots. It is possible both for single transmission devices 3 to broadcast their own local services and for a plurality of transmission devices 3 to be combined into local groups.

Normally, the time slots for the individual information presentations or services are not distinctly and definitely separate from one another. This has technical reasons, because usually what are known as interleaver and error recognition or error correction mechanisms are provided which prompt the data to be “dispersed” in the transition ranges.

FIG. 4, which shows a detail from a broadcast radio transmission signal in the range of a local time window with time windows reserved for local information presentations, shows transition intervals in each case before and after the time intervals for the local time window, that is to say at the start and at the end of a local time window. These transition intervals ensure that the transition between the global time windows and the local time windows are assuredly separate from one another. The transition intervals are used to transmit no relevant data but rather “empty packets”, for example in the form of MPEG2 transport steam empty packets within the context of the MPEG2 standard, the loss of which in the event of interference in broadcast radio transmission signals does not affect the reception of the global information presentations. The transition intervals should be long enough for data from local services never to overlap data from global services, in spite of the dispersals by interleaver and error recognition or error correction mechanisms.

The error recognition or error correction methods are used to recognize and if possible correct errors in the transmission of information. These error recognition and error correction methods are sufficiently well known. In this context, before these useful data are transmitted, an additional redundancy in the form of additional bits is inserted, in principle, said additional bits being able to be used at the receiver end to determine errors and error positions.

When cluster errors occur, although they can be recognized it is only possible to correct them in exceptional cases. A cluster error is a type of error where a relatively large cohesive sequence of bits is erroneous. The interleaving method is used to put the bits of a data packet, i.e. a group of data, in an order which is unsorted at first glance. When a cluster error now arises, it acts, following reconversion into the sorted order, as a relatively large set of individual bit errors which can then be corrected on the basis of the available error correction methods. The bit errors are not cohesive as in the case of the cluster errors.

If the broadcast radio transmission signals are transmitted as a transport datastream which is encoded on the basis of the MPEG standard, for example, using the interleaving method, where individual data items from respective data groups in the transport datastream are scrambled together, the transition intervals ensure that a time interval for the broadcast radio transmission signal, which interleaving and/or error control methods affect without influencing the broadcast radio transmission signal outside of the time interval, does not cover both global and local services. That is to say that in the case of the receiver the influence of the interleaving method can be removed for the global time windows at any rate, even if different data are transmitted by the individual transmission devices 3 in the local time windows and interference means that the data in the local time windows are disturbed or unusable.

On the basis of parameterization options for the DVB-H standard, transition intervals can be calculated as follows, for example:

| System component | | | | |
|---|---|---|---|---|
| to be considered | Required size of transition interval [bits] | | | |
| External FEC and | 2*204*8 | | | |
| external interleaver | | | | |
| Internal FEC | 2*6 | | | |
| Internal | | 2k mode | 4k mode | 8k mode |
| interleaver | QPSK | 24* (126*2) | 48* (126*2) | 96* (126*2) |
| | 16 QAM | 24* (126*2) | 48* (126*4) | 96* (126*4) |
| | 64 QAM | 24* (126*6) | 48* (126*6) | 96* (126*6) |
| Aggregate | | 2k mode | 4k mode | 8k mode |
| | QPSK | 9324 | 15372 | 21420 |
| | 16 QAM | 15372 | 27468 | 39564 |
| | 64 QAM | 27468 | 51660 | 75852 |

In this context, FEC means the error correction mechanism (Forward Error Correction), QPSK means Quaternary Phase Shift Keying and QAM Quadrature Amplitude Modulation.

The external error correction mechanism and the external interleaver for the transport stream packets, i.e. for error recognition and correction at the physical transmission level, require a transition interval of 2*204*8 bits.

The internal error correction mechanism at symbol level requires a transition interval size of 2*6 bits.

The internal interleaver for the interleaving method at symbol level requires different sizes of transition interval on the basis of the mode (2k, 4k or 8k).

By way of example, in a common-frequency network operating in 8k mode with 16 QAM modulation, transition intervals of at least 39 564 bits are thus required. On the basis of a cycle time of 8 seconds between two successive time slots for local services, this corresponds to use of approximately 10 kbit/s.

1. A method for broadcast radio transmission of a multiplicity of different information presentations in a terrestrial common-frequency broadcasting network (1) on a shared channel with broadcast radio transmission signals using the time slot method, in. which every information presentation has at least one associated transmission time slot for broadcast radio transmission of the information presentation and a broadcast radio transmission signal has a multiplicity of global time windows over time with at least one respective transmission time slot, and the broadcast radio transmission signal is broadcast by a plurality of is transmission devices (3), which are arranged at a physical distance apart, such that the global time windows of the broadcast radio transmission signals which are broadcast by the transmission devices (3) contain the same information presentations, and the association between the transmission time slots in the global time windows and the information presentations is identical, where the broadcast radio transmission signals also have local time windows with transmission time slots which are associated with local information presentations, with broadcast radio transmission signals which are broadcast by at least two physically spaced transmission devices (3) on the same channel and have identical information presentations in the global time windows having differing information presentations in local time windows, wherein broadcast radio transmission signals have at least one transition time interval in the transition between a global time window and a local time window and/or in the transition between a local time window and a global time window.

2. The method as claimed in claim 1, wherein the transition interval is at least as long as the length of the time interval affected by the broadcast radio transmission signal prior to the transition interval by interleaving and/or error control methods, which means that the broadcast radio transmission signal is no longer affected thereby after the that the broadcast radio transmission signal after the transition interval.

3. The method as claimed in claim 1, wherein the transition time interval is used to transmit digital empty packets of defined content which are not relevant to the transmitted information.

4. The method as claimed in one of the preceding claims claim 1, characterized by variable association of the length of the time slots in global and/or local time windows and/or the length of the global and/or local time windows.

5. A transmission device (3) for broadcast radio transmission of a multiplicity of different information presentations in a terrestrial common-frequency broadcasting network (1) on a shared channel with broadcast radio transmission signals using the time slot method with the method as claimed in claim 1, having a radio transmission unit and a mixing unit for mixing information from different information presentations into the broadcast radio transmission signal, where the mixing unit is set up to mix local information presentations into transmission time slots in local time windows for the broadcast radio transmission signal, with broadcast radio transmission signals which are broadcast by at. least two physically spaced transmission devices (3) and have identical information presentations in the global time windows having differing information presentations in local time windows, wherein the transmission device (3) provides transition intervals in the transition between a global time window and a local time window and/or in
the transition between a local time window and a global time window.

6. A reception device for receiving broadcast radio transmission signals transmitted using the method as claimed in claim 1, where the broadcast radio transmission signals respectively have a multiplicity of different information presentations' and every information presentation has at least one associated transmission time slot for broadcast radio transmission of the information presentation, and a broadcast radio transmission signal has a multiplicity of global time windows over time with at least one transmission time slot, and the global time windows broadcast radio transmission signals which are broadcast simultaneously by a plurality of transmission devices (3) arranged at a physical distance from one another contain the same information presentations. and the association between the transmission time slots in the global time windows and the information presentations is identical, having a radio reception unit and a decoding unit for decoding the received digital broadcast radio signals, wherein the decoding unit is set up such that transmission time intervals in the transition between a global time window and a local time window and/or in the transition between a local time window and a global time window are taken into account in extracting local information presentations in the broadcast radio transmission signal from transmission time slots in local time windows for the received broadcast radio transmission signal which are respectively associated with the local information presentations, with broadcast radio transmission signals which are broadcast by at least two physically spaced transmission devices (3) on the same channel having differing information presentations in regional time slot groups.
